(19) United States
(12) Patent Application Publication
(10) Pub. No.: US 2006/0210676 A1
(43) Pub. Date: Sep. 21, 2006

(54) Food container particularly for forming a party platter or the like

(75) Inventor: Laszlo Knebl, New South Wales (AU)

Correspondence Address: BROWDY AND NEIMARK, P.L.L.C.;624 NINTH STREET, NW, SUITE 300, WASHINGTON, DC, 20001-5303, US

(73) Assignee: MQF Pty Ltd, Greenarce (AU)

(21) Appl. No.: 11/369,205

(22) Filed: Mar. 7, 2006

(30) Foreign Application Priority Data
Mar. 7, 2005 (AU) 2005901054
Mar. 22, 2005 (AU) 2005901408

(51) Int. Cl. A23B 7/148

(52) U.S. Cl. 426/106

(57) ABSTRACT

A container for use in forming a sealed package has a base a first end wall (16), two converging side walls which either meet at an end, or join a second wall which is shorter than the first wall. The container may contains a food product which is typically provided as a series of discrete pieces or units. The sides of the container define interlocking means, in the form of cylindrical depending lugs and mating lugs or apertures such that a plurality of such containers can be attached or interlocked to one another along their sides, to form an assembly of such containers. It is preferred that the angle subtended by the side walls and divided into 360° produces an integer such that when sufficient containers are joined side wall to side wall the resultant combination of units is generally circular.

### CROSS-REFERENCE TO RELATED APPLICATIONS

The present application claims priority from Australian Provisional Patent 2005901054, and Australian Provisional Patent 2005901408 filed on 7 Mar. 2005, 22 Mar. 2005, the contents of which are incorporated herein by reference.

### FIELD OF THE INVENTION

This invention relates to a food container particularly for forming a party platter or the like.

### BACKGROUND OF THE INVENTION

Party platters are sold by supermarkets, delicatessens and the like. A typical party platter comprises a circular or oval platter or plate, typically with a circular container holding a dip of some sort in the centre of the platter. Around the outside of the dip a series of stacks of different food products, typically small goods such as sliced salami, sausages, sliced ham, olives, gherkins, cubed cheeses or the like, are arranged. Generally speaking the food stacks are shaped like a sector of a circle, in plan view.

Although, many supermarkets provide party platters, often the provision of such platters is not profitable or cost effective. That is because it is an expensive and labour intensive process to create the platters, as they are typically assembled by hand. First, any food products which are not already diced or sliced into bite-sized pieces require slicing in the case of hams and salamis and the like, or cubing, in the case of cheeses or the like. Next the food products have to be weighed and then stacked in generally triangular piles, and subsequently the entire platter has to be wrapped in cling-film or the like.

Aside from the labour intensive manufacture of such platters, the fact that they do take time to assemble means that they have to be ordered by customers in advance, typically from a brochure which a customer looks up and from which a particular platter is ordered and subsequently assembled. Such platters have a short shelf life and cannot therefore be displayed for impulse purchase by customers.

One additional problem is cross-contamination of the different foods on the platter. This is a particular problem if the platter includes both wet foods such as olives, gherkins or the like, as well as dry foods, such as crackers. Liquids from the wet foods often soften the dry foods such as crackers and limit the length of time for which the platter may be prepared prior to use.

The present invention seeks to provide improved packaging means for forming a party platters, or the like, which may overcome some of the disadvantages of the prior art.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

In a first aspect the present invention provides a container for food products formed from a sheet of material having a base and a top, at least two opposed converging side walls, and a first end wall, and wherein a peripheral flange extends around the top of the container, and wherein one or more male connecting means in the form of depending lugs are defined in the flange of one side wall and female connecting means are defined in the flange of the other opposite side wall such that two such containers can be attached or interlocked to one another along their sides.

In use the containers will be filled with food products and sealed. The depending lugs allow the containers to be run and sealed on conventional commercial sealing apparatus. Platters can be assembled by conjoining multiple containers. By providing a series of discrete sealed pockets, the different foods for the platter may be kept separate. This allows both wet and dry foods to be sold in the same platter.

The containers may be gas flushed prior to sealing. This improves the shelf life of the food products. Further this enables sealed containers to be displayed to customers for impulse purchase, which is not currently possible with existing methods for preparing platters.

Typically, in the platter, different pockets will contain different food products from other pockets, although some products may be contained in more than one pocket.

It is a preferred feature that at least some embodiments of the container are microwaveable. In this way a container of, say sausage rolls, can be heated in a microwave and conjoined with other containers of food products which are typically eaten cold. It then become possible to assemble platters which provide both hot and cold foods which is not currently possible.

It is preferred that the platter defines a central aperture for supporting a container of dip, sauce or the like.

The wall of the central aperture may be higher than the outer edge wall of the platter so that the container slopes upwards from its outer edge towards its centre.

The base of one or more of the pockets may define a recess which may be reversed to define a protrusion thereby raising the level of any food product in the pocket. This allows the pockets to be sealed allowing head space for the food product and at the same time by reversing the recess, raises the level of the food product in the pocket allowing easier access.

In one version the female connecting means comprises lugs having a diameter slightly greater than a diameter of the male depending lugs.

In another version, the female connecting means comprises apertures having a diameter slightly greater than a diameter of the male depending lugs.

The converging side walls may be linked by a second end wall which is shorter than the first end wall or may meet at a corner.

It is advantageous that the longer end wall is lower in height than the second end wall or corner, so that the sides of the container extend generally upwards from the first wall to the second end wall or corner.

In a preferred embodiment the angle subtended by the converging side walls and divided into 360° produces an integer so that when sufficient containers are joined side wall to side wall the resultant combination of units is generally circular.

Most preferably the angle which is subtended between the side walls of the container is 45 or 60° or 90°.

In one embodiment the second end wall is curved as is the first end wall.

The curved walls may be arcuate and concentric or non-concentric.

In another embodiment, the second end wall is straight.

The base of the container may define a recess which may be reversed to define a protrusion thereby raising the level of any food product in the container.

Because of the shape of the container, as the container is emptied onto the platter, the food product will be deposited in a pile/stack of the correct configuration for the platter.

### DESCRIPTION OF THE DRAWINGS

Specific examples of the present invention will now be described, by way of example only, with reference to the accompanying drawings in which:

FIG. 1 is an perspective view from above of a first embodiment of a container for food products;

FIG. 2 is an underneath plan view of the container of FIG. 1;

FIG. 3 is a sectional view on lines III-III of the container of FIG. 2;

FIG. 4 is a perspective view from below of the container of FIG. 1;

FIG. 5 is an end view of the container of FIG. 2;

FIG. 6 is an pictorial view of a second embodiment of a container unit for food products;

FIG. 7 is a top view of the container shown in FIG. 5;

FIG. 8 is a section on lines VIII-VIII of FIG. 7;

FIG. 9 is a top view of six units such as those shown in FIG. 5 interlocked together to form a cylindrical platter each containing multiple discrete pieces of a particular food product;

FIG. 10 shows a die pattern for forming a plurality of containers as shown in FIG. 6 by a thermoforming process;

FIG. 11 illustrates the interlocking of flanges of the container of FIG. 6;

FIG. 12 is a pictorial view of a four containers according to third embodiment of the invention, the containers being similar but not identical to the first embodiment shown FIG. 1, partially assembled into a platter.

FIG. 13 is a pictorial view of a platter assembled from six containers similar to those shown in FIG. 6;

FIG. 14a is an isometric view showing an apparatus for filling and sealing preformed containers such as those shown in FIG. 13;

FIG. 14b is a schematic view illustrating a thermoform rollstock apparatus for making and sealing containers embodying the present invention;

FIG. 15 is a plan view of a further embodiment of a container for food products having a straight outer edge;

FIG. 16 is a plan view of six such containers interconnected to form a platter;

FIG. 17 is a plan view of a further embodiment of a container unit for food products;

FIG. 18 is a section on lines XVIII-XVIII of FIG. 17;

FIG. 19 is a top view of six units such as those shown in FIG. 17 interlocked together to form a cylindrical platter;

FIG. 20 is a plan view of a yet further embodiment of a container unit for food products;

FIG. 21 is a section on lines XXI-XXI of FIG. 20;

FIG. 22 is a top view of six units such as those shown in FIG. 21 interlocked together to form a hexagonal platter;

FIG. 23 is a plan view of a yet further embodiment of a container unit for food products;

FIG. 24 is a section on lines XXIV-XXIV of FIG. 24;

FIG. 25 is a top view of six units such as those shown in FIG. 24 interlocked together to form a petaloid or flower shaped platter;

### DETAILED DESCRIPTION OF THE PREFERRED EMBODIMENT

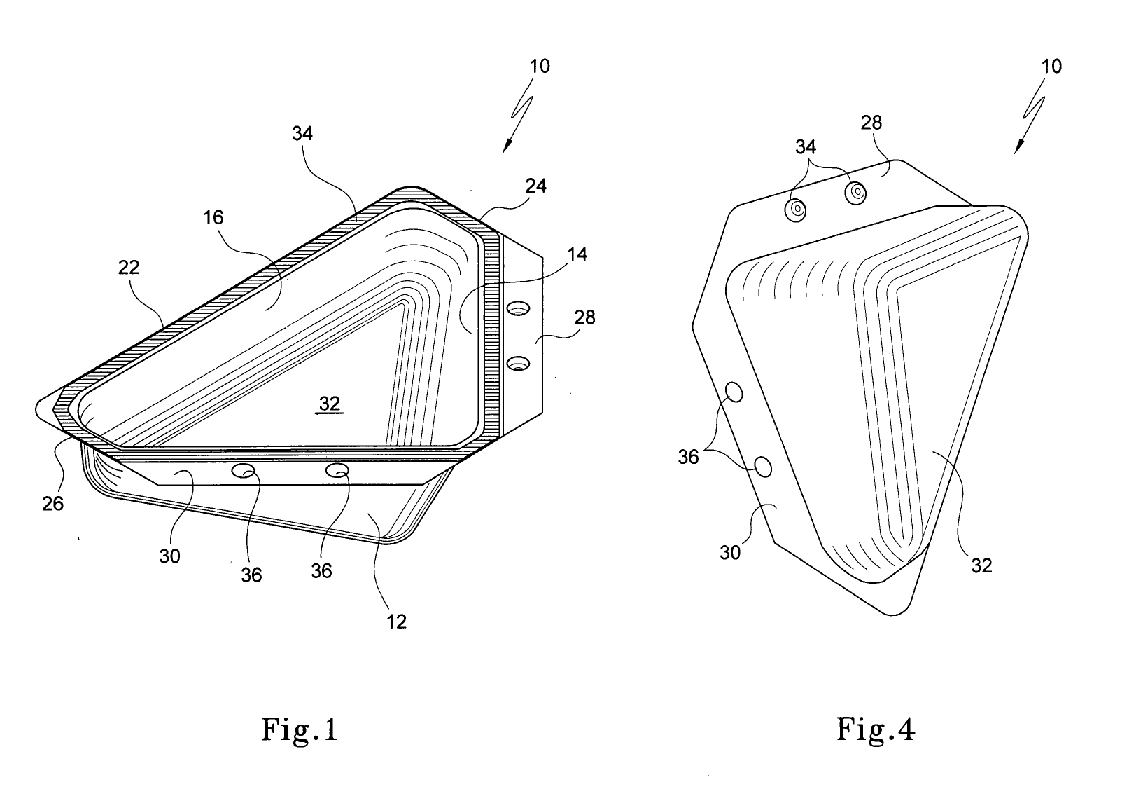

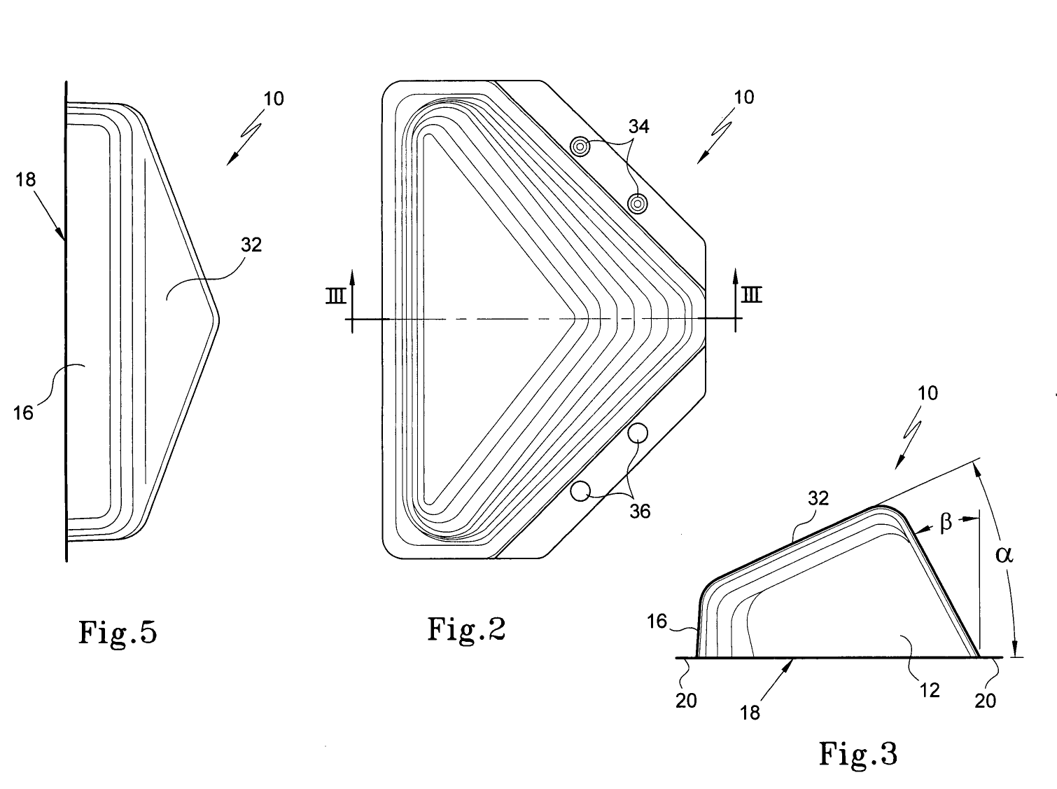

Referring to the drawings, FIGS. 1 to 5 shows a first container 10 for containing food products. In plan view the container is generally triangular but with rounded corners where the two side walls 12, 14 and the end wall 16 of the container meet.

At the top 18 of the container, an external flange 20 is defined which extends in a plane around the perimeter of the top of the container. The width of that portion 22 of the flange 20 which extends along the top of the rear wall 16 is typically of the order of 6-10 mm . Two relatively shorter flange portions 24, 26 are located above the rounded corners where the side walls 12 and 14 meet the end wall 16 and extend at 90° to the flange portion 22. Those portions 28 and 30 of the flange 20 which extend above the side walls 14 and 12 respectively are relatively wider than flange portions 22 to 26, and are typically of the order of about 20mm wide.

The base 32 of the container is generally triangular in shape and is oriented at and angle α of about 25° relative to the plane of the top 18/flange 20 of the container (best seen in FIG. 3). The side walls 12 and 14 meet at and angle of 9020 and with reference to FIG. 3, the join between the two side walls is oriented at an angle β of about 28°. The function of the particular and unusual shape of the container is explained in more detail below.

A sealing strip 34 of heat activated adhesive or the like which assists in the bonding of a sealing web to the container, extends around the flange which may be used to seal a cover over the container, after the container has been filled. Alternatively the sealing web may be heat sealed to the container. The strip 34 extends around the perimeter in an unbroken loop. Means for interlocking a container 20 to an adjacent container are provided in the wider flange portions 28 and 30. Specifically, two depending cylindrical lugs 34 depend from flange 28. These are formed by deformations in the sheet of plastic from which the flange and container body is moulded. Two circular holes 36 of a diameter equal to or marginally less than the outside diameter of are defined in the other flange 30.

Up to four containers 10 can be interlocked together. Flange 28 may be interlocked to flange 30 of an adjacent identical container by placing flange 28 over flange 30 of the adjacent container aligning the lugs 34 over the holes 36 and pressing the flanges together. A third container may have its flange 28 interlocked to the free flange 30 of the two joined containers in the same way, and a fourth may have its flanges 28 and 30 connected to the free flanges 28 and 30 of the three conjoined containers to define a ring of four conjoined containers.

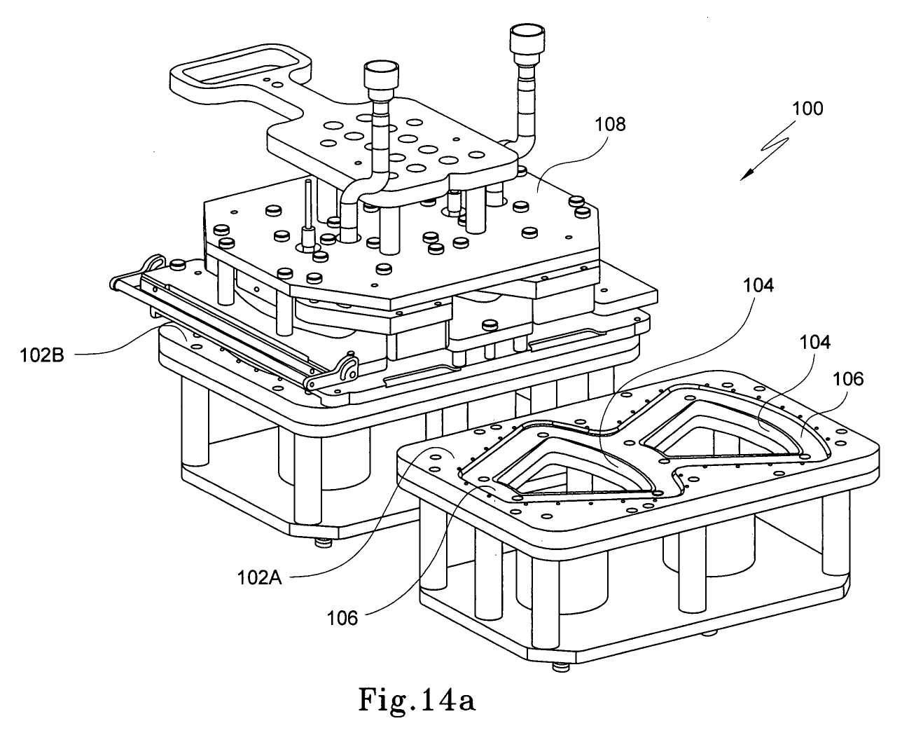

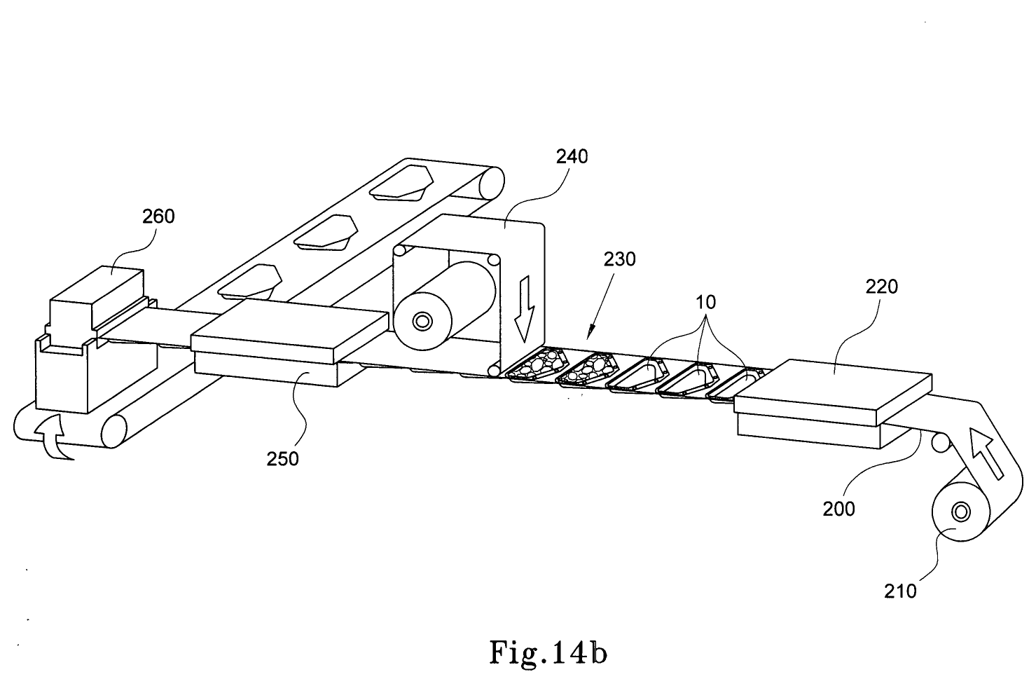

The containers 10 are intended to be sold pre-filled each typically containing multiple discrete pieces of a particular food product and sealed with a sealing sheet of plastic, aluminium or other suitable material bonded to the flange 22 to maintain product integrity and freshness. Various options exist for manufacturing the sealed containers. In one process the containers are pre-moulded, either at a food processing factory or elsewhere and transported to the factory. The pre-moulded containers may be filled automatically, or by hand, with a food product which is pre-sliced or diced to the appropriate sized pieces and sealed. The same factory may fill and seal similar containers with a multitude of different food products, in batches. A machine for performing this function is described in more detail below with reference to FIG. 14.

At a supermarket, delicatessen or the like, a platter may be assembled by interlocking combinations of different containers each typically containing a different food product. Different combinations of food product can be provided. The resultant platters may be provided to customers still sealed and the customer can open the seals on the containers place an inverted plate over the top of the platter and invert the plate and containers to transfer the contents to the plate. Because of the shape of the containers 10, the pre-sliced or pre-diced foods are constrained in the container in the correct shape to form a stack for a platter. Alternatively, these steps may take place at the supermarket or delicatessen and the platter may be provided to the customer readily opened on a plate. In a variation, the containers 10 of food products may simply be sold as they are for customers to assemble their own platters at home. Customers can then make up their own platters as they wish, with combinations of foods selected by themselves. This has the added advantages of the sealed containers providing improved hygiene and reduced likelihood of contamination of the contents and also being easier to carry than a platter. Product separation, inherent in the design, also prevents cross-contamination of the individual platter constituents (i.e. meat or cheese with liquid from olives or gherkins) which reduces the use by time of the platter thus allowing earlier assembly of the platter and enhancing the quality of the whole platter.

FIG. 14a shows a machine 100 for filling pre-formed containers of the type shown in FIGS. 1 to 5, although it is to be noted that the table 102 of the machine 100 is set up to receive pre-moulded containers 110A of a different shape to FIG. 1 to 5 which are described in more detail below with reference to FIG. 13, six of v which interlock to form a platter, although the principles behind the filling and sealing of the containers remain the same. The machine includes two substantially identical juxtaposed tables 102A, B. Bach table 102A, b defines two apertures 104. for receiving containers 11A. A recess 106 extending around the aperture supports the flange of the containers The containers are placed in the apertures on the table and filled, or may be loaded onto the table pre-filled. The upper part 108 of the apparatus is then moved into position above the container and the container is flushed with gas to create an appropriate atmosphere for storage of the product, depending on the type of product, and the container is then sealed closed with a plastic film. While the containers in one of the tables 102A are being sealed, the other table 102B sealed containers may be unloaded from the other table and loaded with fresh containers 110A for sealing after those on table 102A have been sealed, to make the manufacturing process quicker valid more efficient

Alternatively, as illustrated in FIG. 14b, particularly for large scale manufacture, the containers may be formed from plastic sheet/film, automatically filled and sealed in one process on a thermoform rollstock machine. In such a thermoforming process packaging material 200 for the base container 10 (thermo forming film) is unwound from a reel 210 , heated in a forming dye 220 in which several containers are formed simultaneously. Typically the material used to form the container is a web of 350 micron PVC with a 51 micron LLDVP (linear low density polyethylene) coating. The formed containers are then loaded manually or automatically. An upper web of packaging material then covers the filled pockets. The upper web 240 forming the seal comprises a web of 15 micron biaxially oriented nylon a layer of 38 micron peelable co-extruded sealant so that the total thickness of the web is 51 micron. Both web products are available from Sealed Air Corporation of New Jersey, USA under their “Cryovac” registered trade mark. The formed containers 10 are then filled either automatically or manually at 230. The upper web 240 of material then covers the filled containers as they are transferred to a sealing die 250. Air is then evacuated from the container and a protective gas is added, if required. The package is then sealed by the application of heat and pressure. The web of packs is then cut using a cutting means 260 to separate the individual packs which are then packed and sold. Typically the containers will be formed and assembled in batches, say a batch of meat sticks first then say sliced salami, then some other food product, and so on.

The individual packs can be specifically designed for the particular product applications, with a vacuum modified atmosphere, with a rigid or flexible film or any aluminium material based combination, with opening and re-closure facility, coding or the like to suit the particular product.

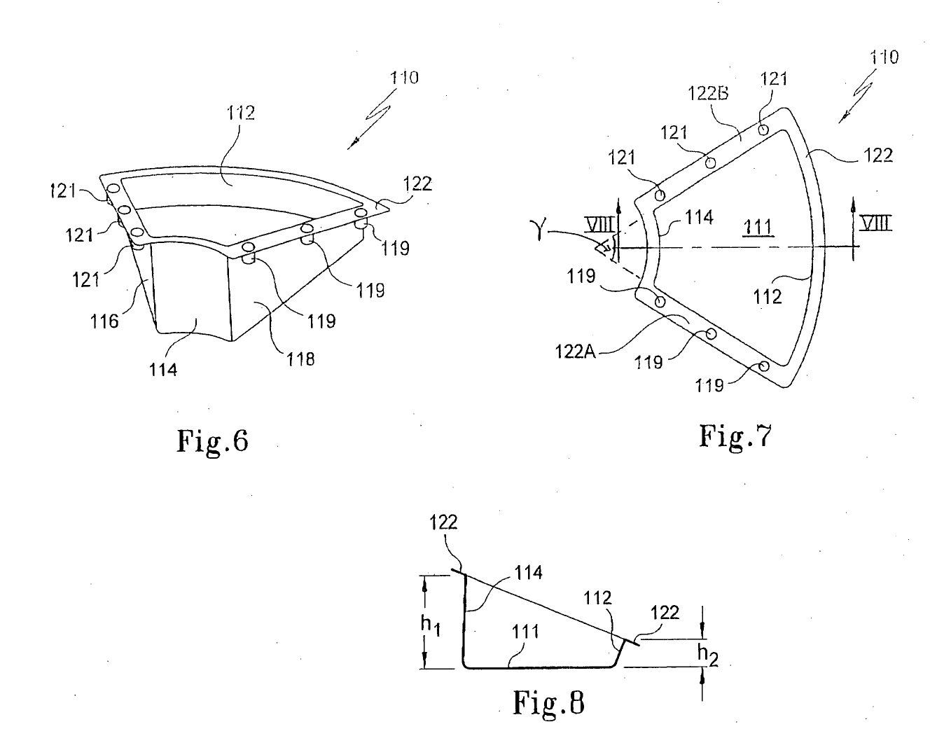

FIGS. 6 to 8 show a second embodiment of a container 110. The container has a generally flat base 111 . With reference to FIG. 7, the container defines a relatively longer arcuate outer wall 112 and a relatively shorter, but concentric, arcuate inner wall 114. The radius of the outer wall is 200 mm and that of the inner wall is 55 mm although these dimensions could be varied. The ends of the arcuate walls are connected by two radially extending straight side walls 116 and 118. The. angle γ subtended by the two side walls is 60°.

In the specific example shown, the outer wall 114 has a height h₁ of 70 millimetres, and the inner wall a height h₂ of 20 millimetres from the base 111 to its top 120. Also as can be best seen in FIG. 8, the outer wall 112, is extends way from the container at an angle of about 110 to 120° rather than being perpendicular to the base 111.

An external flange 122, extends around the perimeter of the top 120 of the container. As shown in FIG. 7, the plane flange is oriented in a plane at an angle of about 30-40o to the plane of the base 111. The part 122A of the flange extending along the top of side wall 118 defines a series of hollow cylindrical depending projections or lugs 119 having a diameter of 7 mm . The part 122A of the flange extending along the side wall 116 defines a similar series of hollow cylindrical depending projections or lugs 121 having a slightly larger diameter of 8 mm .

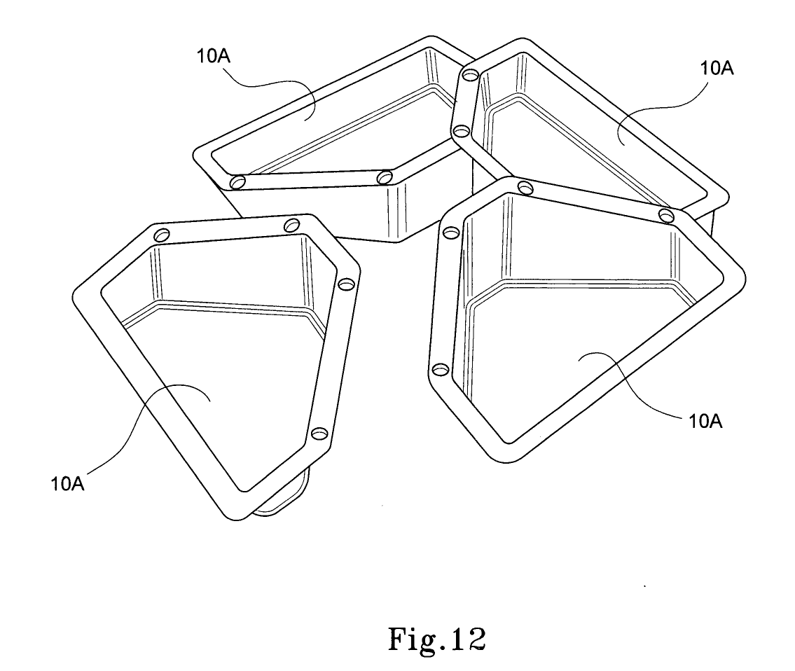

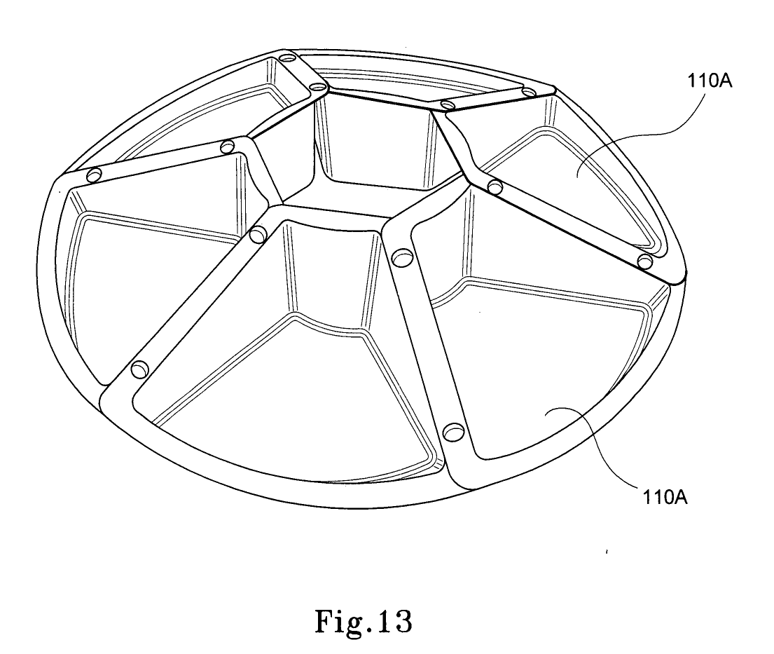

As illustrated in FIG. 11, the lugs 121 act as female engaging means and the lugs 119 act as male engaging means and press fit into the recesses defined on the side of a contiguous container unit. This interlocks the six containers together into a platter.

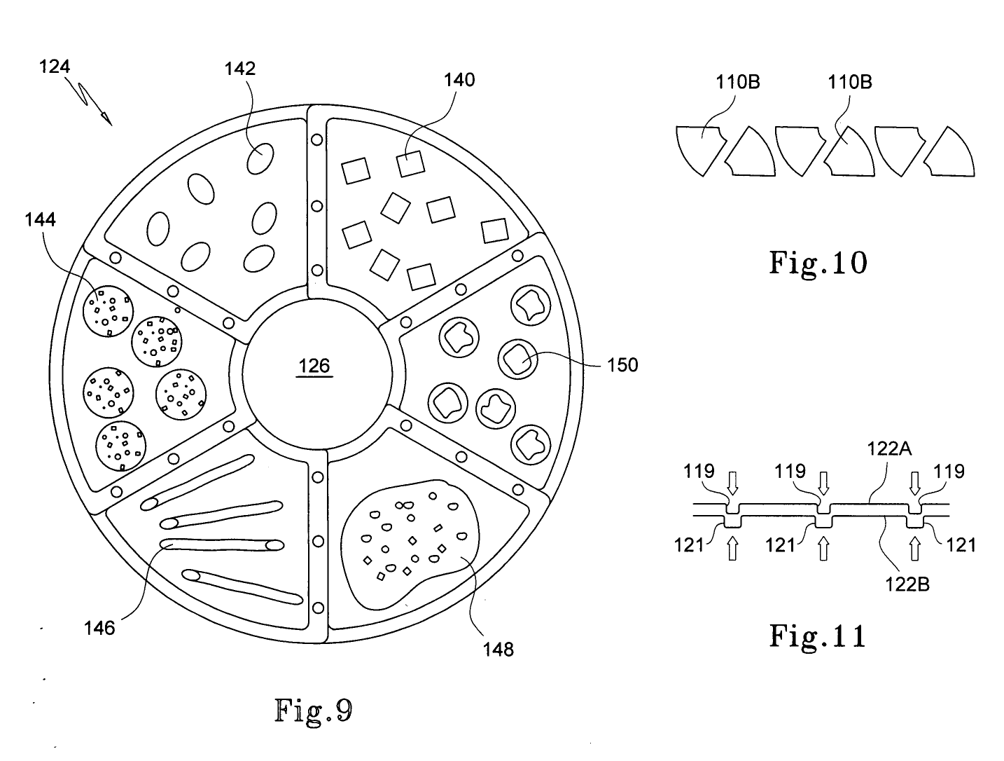

FIG. 9 illustrates six such containers pre-filled with various food products such as cheese cubes 140, olives 142, salami 144, meat sticks 146, potato salad. 148 crackers 150 sealed with clear film 151 and assembled with the side wall 116 of one container contiguous and interlocked to the side wall 118 of another container. The six containers together define a generally circular platter 124, having a circular aperture 126 at the centre thereof. A circular container of a dip, sauce or the like may be supported in the circular aperture 126.

FIG. 10 showing one suitable die pattern for manufacturing the containers 110 in moulds 110b in the thermoforming process discussed above.

FIG. 12 is a pictorial view of a four containers 10A according to third embodiment of the invention. The containers are essentially identical to that shown in FIGS. 1 to 5 except that the interlocking means comprise smaller and larger interlocking lugs as described above in relation to the embodiment of FIG. 6 to 8 rather than lugs and holes. Four such containers are shown partially assembled into a platter.

FIG. 13 is a pictorial view of six containers 110A according to a fourth embodiment of the invention. The containers are substantially identical to the embodiment of FIGS. 6 to 8 except that the external edge of the flange 122 is straight rather than curved. The containers are shown formed in plastic and assembled into a platter.

FIGS. 15 and 16 show a yet further embodiment of a food container 300. The container 300 is similar to that shown in FIGS. 6 to 8 except that the outer wall 312 is straight rather than arcuate. In all other respects the containers are the same and in particular container 300 includes an external flange 322 projecting from the top edge of the container with the flanges on respective side walls of the container defining a series of depending lugs 319 and 321, for use in interlocking like containers together, FIG. 16 shows a hexagonal platter 320 which has been assembled from six such containers.

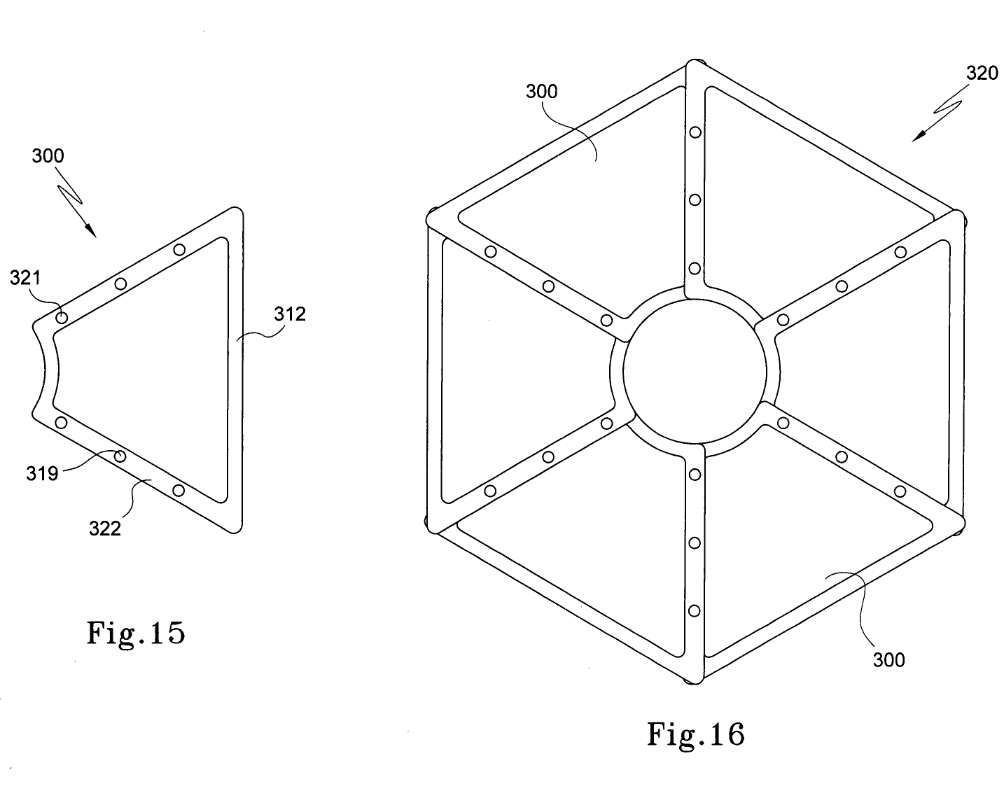

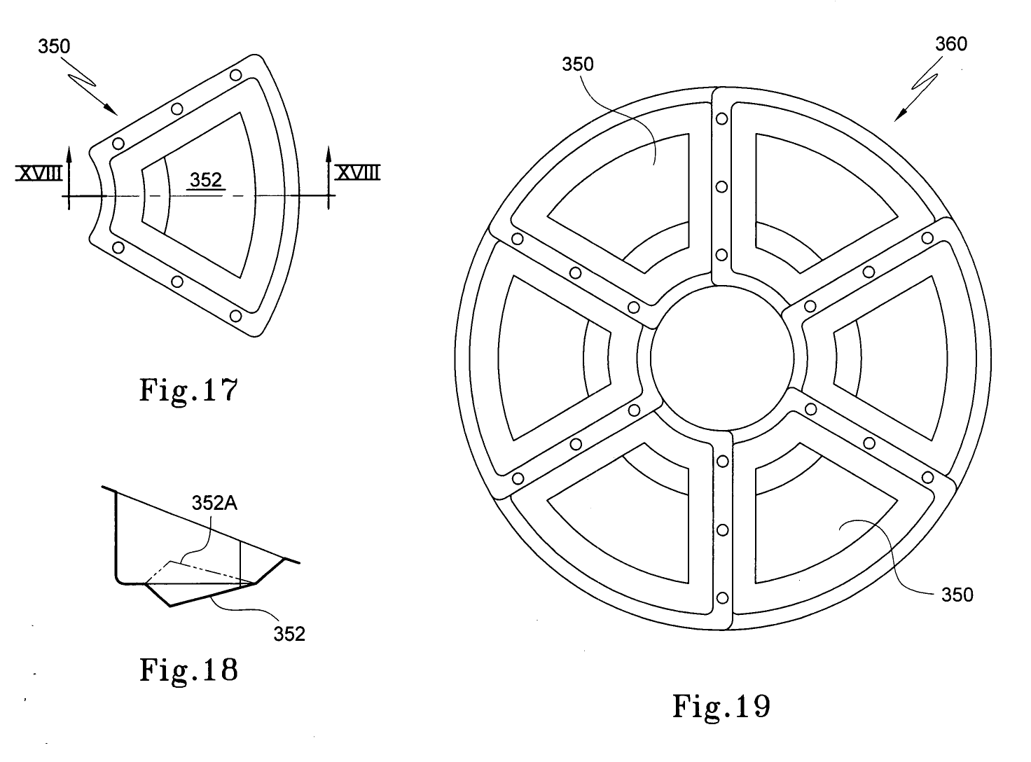

FIGS. 17 to 19 illustrates a yet further embodiment of a container which includes a pop-up base 352, best seen in FIG. 18. In all other respects, the container is the same as that shown in FIGS. 6 to 8. As is best seen in FIG. 18, the pop-up base comprises a recess 352 formed in the floor of the container. In the recessed position shown in FIG. 18 the container may be filled with food product and sealed while allowing headspace for the product. Prior to serving the recess can be pushed or popped upwards so as to define a raised bump or protrusion 352A shown in dashed lines in FIG. 19, which has the effect of raising the food product in the container to make it easier to access. The containers interlock to form a platter 360 in the same way as those of FIGS. 6 to 8.

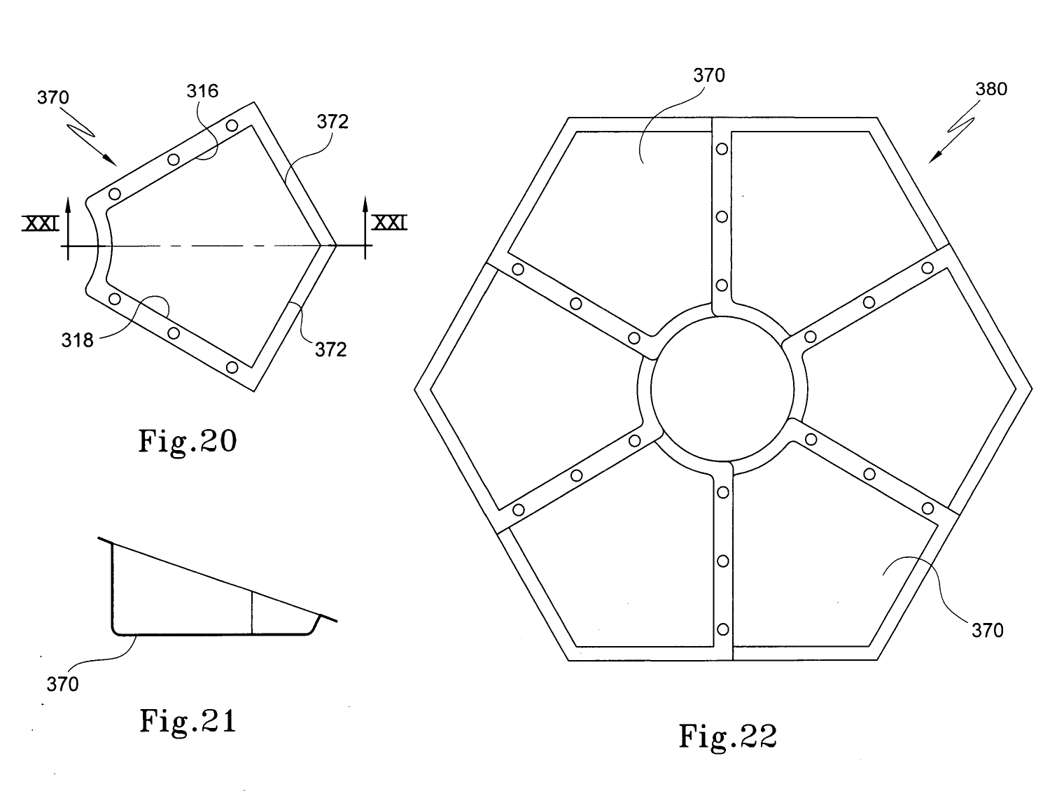

FIGS. 20 to 22 show a yet further container shape, 370 which again is similar to the container of FIGS. 6 to 8 with the difference being the shape of the outer wall being two straight edges perpendicular to the side walls 316, 318 meeting at an angle, so that when six such containers are conjoined, as shown in FIG. 22, they forn a hexagonal platter 380.

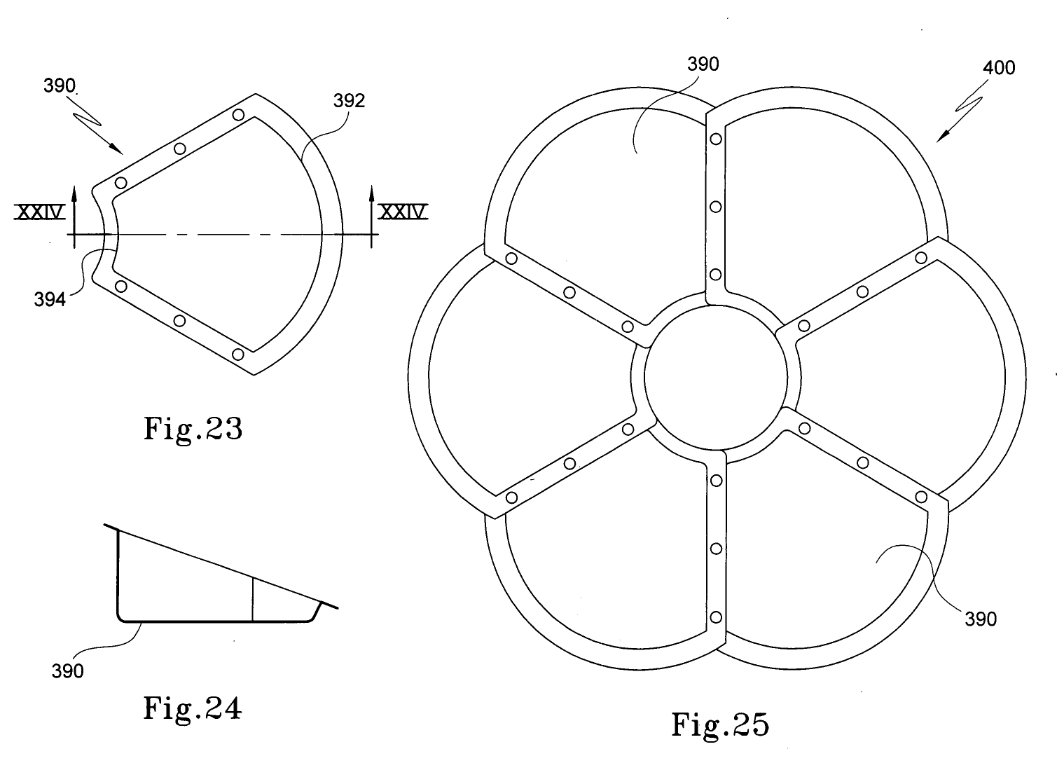

FIGS. 23 to 25 show a yet further container shape 390. In this embodiment, the container is again very similar to that shown in FIGS. 6 to 8 except that the curvature of the outer wall 392 is greater than that of the inner wall 394 so that when six such containers are conjoined as shown in FIG. 25, a platter 400 having a flower-like shape is formed.

It will be appreciated that other container shapes may be used and that although platters formed from four and six containers are disclosed the angles subtended between the side walls of the containers may be varied, for example to 45° to allow platters to be formed from eight containers, or to other angles to allow platters to be formed from more than eight or other numbers of containers, if desired.

Further although the specific embodiments described above refer to the containers being formed from a plastics material, other materials such as Aluminium, or even cardboard or coated paper could be used to form the container, particularly where the container is preformed and subsequently sealed by apparatus such as is shown in FIG. 14.

The supply of the food products in individual containers or pockets also allows platters to be formed having dry foods, such as crackers and the like, earlier than would normally be possible since the containers/pockets keep such dry products separate from wet products such as olives, gherkins and the like. When traditional platters are formed the wet products cause dry products to soften, which means that they have a limited life prior to use.

It will also be appreciated that the provision of the present invention allows supermarket, caterers and the like to assemble and provide platters which are sealed, without the need to touch or handle the food product in any way, which improves hygiene and reduces the risk of contamination.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

The claims defining the invention are as follows:

1. A container for food products formed from a sheet of material, the container defining a base, a top, at least first and second opposed converging side walls, and a first end wall, and wherein a peripheral flange extends around the top of the walls of the container, and wherein one or more male connecting means in the form of depending lugs are defined in the flange of one side wall, and wherein female connecting means are defined in the flange of the other side wall so that two such containers can be attached or interlocked to one another along their respective sides, to form an assembly of such containers.

2. A container as claimed in claim 1 wherein the female connecting means comprise lugs having an external diameter slightly greater than an external diameter of the male depending lugs.

3. A container as claimed in claim 1 wherein the female connecting means comprise apertures having a diameter approximately the same as the external diameter of the male depending lugs so as to form an interference type fit.

4. A container as claimed in claim 1 wherein the first end wall has a first height and the converging side walls are linked by a second end wall which has a second height greater than the first height of the first end wall.

5. A container as claimed in claim 1 wherein the first end wall has a first height and the side walls meet at a corner having a height and wherein the first height is lower in height than the second end wall or corner, so that the sides of the container extend generally upwards from the first wall to the corner.

7. A container as claimed in any preceding claim wherein the angle subtended by the converging side walls and divided into 360° produces an integer

8. A container as claimed in claim 7 wherein the angle which is subtended between the side walls of the container is 45° or 60°or 90°.

9. A container as claimed in claim 1 wherein the flange extends in a plane which is oriented at an angle of 20 to 30° relative to the plane of the base.

10. A container as claimed in claim 1 wherein the depending lugs comprise deformations in the sheet of material form which the container is formed.

11. A container as claimed in any preceding claim containing multiple discrete pieces of one particular food product and sealed with a film or foil attached to the flange.

12. A container of food products, the container being formed from a sheet of material and defining a base, a top, at least first and second opposed converging side walls, and a first end wall, and wherein a peripheral flange extends around the top of the walls of the container, and wherein one or more male connecting means in the form of depending lugs are defined in the flange of one side wall, and wherein female connecting means are defined in the flange of the other side wall so that two such containers can be attached or interlocked to one another along their respective sides, the container containing a plurality of multiple discrete pieces of a food product and being sealed with a foil or film attached to the flange.

13. A container as claimed in claim 12 wherein the first end wall has a first height and the converging side walls are linked by a second end wall or corner which has a second height greater than the first height of the first end wall.

14. A container as claimed in claim 13 wherein the angle which is subtended between the side walls of the container is 45° or 60° or 900°

15. A container as claimed in claim 14 wherein the depending lugs comprise deformations in the sheet of material form which the container is formed.

16. A platter of differing food products comprising a plurality of containers of food products; wherein
each container is formed from a sheet of material and defines a base, a top, at least first and second opposed converging side walls, and a first end wall, and wherein a peripheral flange extends around the top of the walls of each container, and wherein one or more male connecting means in the form of depending lugs are defined in the flange of one side wall of each container, and wherein female connecting means are defined in the flange of the other side wall of each container, each container containing a plurality of multiple discrete pieces of a food product, and wherein
the plurality of containers are interlocked to one another along their respective sides by means of the male and female connecting means to define said platter.
